(19) United States
(12) Patent Application Publication
(10) Pub. No.: US 2020/0071238 A1
(43) Pub. Date: Mar. 5, 2020

(54) COMPOSITIONS COMPRISING INTERCALATED MATERIALS AND METHODS OF USE THEREOF

(71) Applicant: Imerys USA, Inc., Roswell, GA (US)

(72) Inventors: David CUMMINGS, Warthen, GA (US); Anthony LYONS, Macon, GA (US); Christopher BOOTHBY, Cumming, GA (US); Philip JONES, Woodstock, GA (US)

(21) Appl. No.: 16/490,169

(22) PCT Filed: Feb. 28, 2018
(86) PCT No.: PCT/US18/20240

§ 371 Date: Aug. 30, 2019

Related U.S. Application Data
(60) Provisional application No. 62/466,832, filed on Mar. 3, 2017.

(51) Int. Cl. C05C 9/00; C05G 3/00

(52) U.S. Cl. CPC C05C 9/005; C05G 3/0052; C05G 3/0082; C05G 3/0041; C05G 3/0029

(57) ABSTRACT

Compositions of clay materials intercalated with urea and/or another material or combination of materials are discussed. For example, the composition may comprise from about 20% to about 65% by weight intercalated urea, with respect to the total weight of the composition. Intercalation may be achieved, for example, by grinding the clay particles with one or more other materials, such that the other material(s) are intercalated into the clay particles. The composition may be formed into pills formulated for controlled release of urea, e.g., for fertilizing soil.

### CLAIM FOR PRIORITY

This PCT International Application claims the benefit of priority of U.S. Provisional Application No. 62/466,832, filed Mar. 3, 2017, the subject matter of which is incorporated herein by reference in its entirety.

### TECHNICAL FIELD

Embodiments of the present disclosure relate generally to compositions intercalated with urea and/or another material or combination of materials. The compositions may exhibit properties of absorption and/or strength, and may be formulated for sustained release of the intercalated material(s), e.g., for fertilization of soil.

### BACKGROUND

Agricultural fertilizers are useful to maintain soil fertility and supplement nutrients needed for crops during the growing season. The benefit provided by the additional nutrients often depends on when they are delivered, wherein poor alignment of plant fertilizer demand and availability can have a serious detrimental effect on production. Sudden delivery of too much fertilizer can be wasteful or even detrimental to plants, while too little fertilizer or delayed delivery of an adequate amount can starve plants. Urea fertilizers provide an important source of nitrogen, but urea can be released from fertilizer too quickly, e.g., due to volatilization as ammonia gas and/or in water run-off While repeated applications of fertilizer could provide a consistent supply of nitrogen, such methods are labor intensive, costly, and impractical. Proper formulation of fertilizer compositions therefore remains a challenge.

### SUMMARY OF THE DISCLOSURE

The present disclosure includes a composition comprising clay particles intercalated with urea, wherein the clay particles comprise kaolinite and have a shape factor less than 30, and wherein the composition comprises from about 20% to about 65% by weight intercalated urea, with respect to the total weight of the composition. The composition may comprise from about 40% to about 65% by weight intercalated urea, with respect to the total weight of the composition, and/or may have an intercalation ratio ranging from about 80% to 100%.

According to some aspects, the clay particles may further comprise at least one smectite clay. Additionally or alternatively, the clay particles may have a shape factor less than 25, less than 20, less than 15, or less than 10. In some examples, the clay particles have a d₅₀ particle diameter greater than 0.5 μm and/or a d₇₀ particle diameter less than 2.5 μm. In at least one example, the clay particles may be in the form of booklets having a thickness ranging from about 10 μm to about 50 μm, from about 15 μm to about 40 μm, or having a thickness greater than 50 μm. The composition may comprise less than 0.1% by weight of surfactant with respect to the total weight of the composition. For example, the composition may not comprise a surfactant.

According to some aspects of the present disclosure, the clay particles intercalated with urea may be in the form of prills, e.g., having an average diameter ranging from about 0.5 mm to about 5 mm, from about 1.0 mm to about 4.0 mm, or from about 2.0 mm to about 3.0 mm. The prills may include a coating that comprises at least one of a polymer, a sulfur compound, a mineral, or a combination thereof. For example, the coating may comprise at least one polymer and at least one clay mineral, such as, e.g., kaolin. In some examples herein, the kaolin of the coating may have a shape factor greater than 30, greater than 40, greater than 50, or greater than 60. For example, the kaolin of the coating may be platy in shape. Any of the compositions described above and elsewhere herein may he controlled-release compositions formulated to release nitrogen at a predetermined rate.

The present disclosure also includes a controlled-release composition comprising clay particles comprising kaolinite and having a shape factor less than 30, urea intercalated into the day particles, and a coating comprising a polymer and a clay mineral having a shape factor greater than 30, wherein the composition comprises from about 20% to about 65% by weight intercalated urea, with respect to the total weight of the composition. In some examples, the composition comprises from about 40% to about 65% by weight intercalated urea, with respect to the total weight of the composition, and/or the composition has an intercalation ratio ranging from about 80% to 100%.

The present disclosure also includes methods of preparing the compositions described above and elsewhere herein. For example, disclosed herein is a method of preparing a composition comprising clay particles intercalated with urea, the method comprising combining clay particles with urea to form a mixture, wherein the clay particles comprise kaolinite and are in the form of booklets, and wherein the mixture comprises from about 30% to about 85% urea by weight with respect to the total weight of the mixture; and grinding the mixture to intercalate the urea into the clay particles. In at least one example, the composition thus produced may have an intercalation ratio ranging from about 80% to 100%.

According to some exemplary methods, the clay particles may comprise from about 2% to about 10% water by weight. With respect to grinding, the mixture may be ground with an attritor mill, for example, or a ball mill, or another suitable milling device. In some aspects of the present disclosure, the mixture may be ground at a speed ranging from about 50 RPM to about 350 RPM for a time ranging from about 30 minutes to about 5 hours. In at least one example, the method further comprises forming the composition into prills, and optionally applying a controlled-release coating to the prills. The controlled-release coating may comprise, for example, at least one polymer and kaolin. The kaolin of the controlled-release coating may be platy in shape, e.g., having a shape factor greater than 30.

The present disclosure further includes methods of using the compositions described above and elsewhere herein as a fertilizer. For example, disclosed herein is a method of fertilizing soil, the method comprising applying a composition to the soil, the composition comprising clay particles intercalated with urea, the clay particles comprising kaolinite, wherein the clay particles have a shape factor less than 30, and wherein the composition comprises from about 20% to about 65% by weight intercalated urea, with respect to the total weight of the composition. The composition may be in the form of prills, for example, having an average diameter ranging from about 0,5 mm to about 5 mm. In some aspects, the composition may have an intercalation ratio ranging from about 80% to 100%.

### BRIEF DESCRIPTION OF THE DRAWINGS

The accompanying drawings, which are incorporated in and constitute a part of this specification, illustrate various exemplary aspects of the disclosure, and together with the description, serve to explain the principles of the present disclosure.

FIG. 1 shows a plot of urea feed vs. urea in the product, as discussed in Example 1.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

Compositions according to the present disclosure may comprise clay particles intercalated with urea and/or one or more other materials. The compositions herein may be formulated for controlled released of the intercalated material(s), e.g., as a fertilizer, and/or may be useful as an additive or filler material.

Clay is a generic term that encompasses a range of hydrous alumino-silicate minerals of varying chemical composition and properties. Exemplary clays suitable for the compositions and methods herein include, but are not limited to, kaolin, smectite clays, and combinations thereof. The clays herein may be obtained from a natural source and/or may he processed.

Kaolin clay typically comprises at least 50% by weight kaolinite. Kaolinite is an aluminum silicate having a layered structure with the chemical formula of A₂Si₂O₅(OH)₄, formed from a tetrahedral sheet of silica (SiO₄) and an octahedral sheet of alumina (AlO₆) linked together through oxygen atoms. The 1:1 layers are held together by hydrogen bonding and can typically withstand grinding without fully delaminating. Kaolin may comprise one or more minerals other than kaolinite, such as one or more smectite clays. Smectite clays are phyllosilicate clay minerals having the structure of a central octahedral sheet between two tetrahedral sheets. Exemplary smectite clays include, e.g., montmorillonite ((Na,Ca)_{0.33}(Al,Mg)₂(Si₄O₁₀)(OH)₂.nH₂O), nontronite, beidellite, and saponite.

In some aspects of the present disclosure, the clay particles may comprise kaolinite, optionally in combination with one or more smectite clays. For example, the clay particles may comprise kaolin. Exemplary kaolin clays suitable for the present disclosure may comprise at least about 50% by weight kaolinite, and less than 50% by weight other minerals. For example, the clay particles may comprise from about 50% to 100% by weight, from about 75% to 100% by weight, or even from about 90% to 100% by weight kaolinite; and from 0 to about 50% by weight smectite clay(s), e.g., from 0 to about 25% by weight, from about 10% to about 40% by weight, or from about 15% to about 35% by weight smectite clay(s). In other examples herein, the clay particles may comprise less than 50% by weight kaolinite and more than 50% by weight smectite clays or other type(s) of clay minerals.

The size of the clay particles may be characterized in terms of the diameter of a sphere of equivalent diameter (“equivalent spherical diameter” (ESD)) that sediments through a fully dispersed suspension of the particles in an aqueous medium. For example, a SEDIGRAPH 5100 instrument (Micromeretics Corp.) may be used to obtain the particle size distribution by plotting the cumulative percentage by weight of particles having a given ESD. For example, d₅₀ is the particle ESD at which 50% by weight of the particles have a smaller ESD. Similarly, d₃₀ is the particle ESD at which 30% by weight of the particles have a smaller ESD, and d₇₀ is the particle ESD at which 70% by weight of the particles have a smaller ESD.

According to some aspects of the present disclosure, the composition may comprise clay particles characterized as having a particle size distribution that is “coarse” as opposed to “fine,” The term “coarse” generally refers to a size distribution wherein less than 30% by weight of the particles have an average diameter below 0.25 μm, whereas “fine” generally refers to a size distribution wherein more than 30% by weight of the particles have an average diameter below 0.25 μm. In some examples of the present disclosure, the composition may comprise clay particles having a d₅₀ particle diameter greater than 0.3 μm, greater than 0.5 μm, or greater than 0.7 μm. Additionally or alternatively, the clay particles may have a d₇₀ particle diameter less than 3.0 μm, less than 2.5 μm, or less than 2.0 μm. In at least one example, the clay particles may have a d₅₀ particle diameter greater than 0.5 μm, and a d₃₀ particle diameter less than 2.5 μm.

In some aspects of the present disclosure, the clay particles may be in the form of booklets, wherein individual clay particles are stacked together. For example, kaolinite particles in a naturally occurring kaolin clay typically exist as individual crystalline platelets, or as booklets of stacked platelets. Without intending to be bound by theory, it is believed that clay particles in the form of booklets may lead to a greater amount of material intercalated into the clay particles due to the greater amount of surface area afforded by the booklets. The dimensions of booklets may vary. For example, the booklets may have a thickness ranging from about 5 μm to about 60 μm, from about 10 μm to about 50 μm, or from about 20 μm to about 40 μm.

The shape of clay particles can be characterized as “platy” or “blocky.” Platy generally describes particles that are more flat and planar (platelike), whereas blocky generally describes particles that are more polyhedral and boxy (blocklike). The differences in shape among various particulate materials may be characterized through their shape factors. The term “shape factor” as used herein refers to the average value (on a weight average basis) of the ratio of mean particle diameter to particle thickness for a population of particles of varying size and shape. Shape factor may be measured using the electrical conductivity method and apparatus described in U.S. Pat. No. 5,576,617. In this method, the electrical conductivity of a fully dispersed aqueous suspension of the particles is measured as they flow through an elongated tube. Measurements of the electrical conductivity are taken between (a) a pair of electrodes separated from one another along the longitudinal axis of the tube, and (b) a pair of electrodes separated from one another across the transverse width of the tube. The shape factor of the particulate material is determined from the difference between these two conductivity measurements. A shape factor greater than 30 generally describes platy materials, whereas a shape factor less than 30 generally describes blocky materials.

The compositions herein may comprise clay particles that are blocky or platy, or a combination of blocky particles and platy particles. For example, the composition may comprise clay particles having a shape factor less than 30 (i.e., less than 30 and greater than 0), less than 25, less than 20, less than 15, less than 10, or less than 5. For example, the clay particles may have a shape factor ranging from about 3 to about 20, or from about 5 to about 10 In other aspects, the clay particles may have a shape factor greater than or equal to 30, e.g., from about 30 to about 60, or from about 40 to about 50. A relatively low shape factor may describe clay particles in the form of booklets rather that individual platelets.

Relatively small molecules such as, e,g, urea, dimethyl sulfoxide (DMSO), formamide, triethanolamine, and/or other molecules, may be within the layers of the clay particles (e.g., kaolinite layers) in a process known as intercalation. Without intending to be bound by theory, it is believed that molecules with a high dipole moment may be capable and/or more readily intercalated between adjacent kaolinite layers hydrogen-bonded together. Table 1 below lists some exemplary molecules that may be included in the compositions herein.

TABLE 1

| Molecule | Dipole moment (Debye) | d(001) spacing |
|---|---|---|
| Pyridine-N-Oxide | 4.28 | 12.52 |
| Formamide | 3.71 | 10.12 |
| N-methylformamide | 3.83 | 10.7 |
| Dimethylformamide | 3.82 | 12.12 |
| Acetamide | 3.76 | 10.9 |
| N-methylacetamide | 3.73 | 11.3 |
| Dimethylacetamide | 3.81 | 12.3 |
| Dimethyl sulfoxide | 4.3 | 11.21 |
| Acetone | 2.91 | 11.18 |
| Urea | 4.56 | 10.8 |
| Hydrazine | 1.85 | 11 |
| Water | 1.85 | 8.4 |

The intercalated material(s) then may affect the physical and/or chemical properties of the clay particles. For example, intercalation typically affects the spacing between crystalline layers due to the inserted material(s) pushing adjacent layers apart. X-ray diffraction (XRD) is a technique that provides information on the unit cell dimensions of a crystalline material, and thus may be used to assess the amount of intercalation through the change in the spacing of adjacent layers upon incorporation of the intercalated material(s).

As an example, the spacing of layers of natural kaolinite in kaolin is about 7 Angstroms, appearing as an XRD peak at 7 Å. As urea is incorporated between the 1 to 1 layers, this spacing between adjacent layers increases. Accordingly, the intensity of the 7 Å peak decreases with intercalation because there are fewer instances of 7 Angstrom spacing. At the same time, the intensity of the peak at 10 Angstroms increases as a signature of the spacing after intercalation of the urea. Prior to intercalation, kaolin does not exhibit a 10 Å peak. A peak at 4 Angstroms also is typically observed only when urea is added to the kaolin, as the 4 Å peak does not occur with pure kaolin. The 4 Å peak is generally interpreted to be associated with free urea. XRD therefore provides a way to measure the amount of interaction through the intercalation ratio:

I_{10 Å}/(I_{10 Å}+I_{7 Å})=Intercalation Ratio Equation 1

where I_{10 Å} is the peak spacing between the 1 to 1 layers created by the intercalation of urea, and the I_{7 Å} is the peak created by the spacing between the 1 to 1 layers in native kaolin.

The compositions herein may have a urea intercalation ratio greater than 70%, e.g., an intercalation ratio greater than 75%, greater than 80%, greater than 85%, greater than 90%, or even greater than 95%. For example, the urea intercalation ratio may range from about 75% to 100%, from about 80% to about 99%, from about 85% to about 98%, from about 90% to about 98%, or from about 95% to about 98%.

Additionally or alternatively, the amount of urea intercalated into the clay particles may be determined from loss on ignition (LOI) measurements. After washing any free urea from the intercalated product, the product may be heated to a sufficiently high temperature (e.g., a temperature of about 1050° C.) to cause the intercalated urea to burn and volatilize. The loss in mass may be attributed to the intercalated urea, after subtracting for loss of water present in the clay. See Example I below, In some aspects of the present disclosure, the composition may comprise from about 20% to about 70% by weight intercalated urea with respect to the total weight of the composition with respect to the total weight of the clay particles and intercalated urea combined). For example, the composition may comprise from about 20% to about 65% by weight intercalated urea, e.g., from about 25% to about 65% by weight, from about 40% to about 65% by weight, or from about 50% to about 60% by weight.

As mentioned above, the compositions and methods herein are not limited to intercalation of urea. Other materials may be within the clay particle layers (e.g., kaolinite layers), such as, e.g., formamide, triethanolamine, and/or other molecules. The skilled artisan may determine the appropriate peak spacing value for determining the intercalation ratio based on the relative molecular size and/or other characteristics of the intercalated materials (see, e.g., Table 1).

Various parameters may affect the ability and degree to which a material may become intercalated into the layers. These parameters may include, for example, the chemical composition and structure of the clay, the shape of the clay particles, the composition and structure of the material(s) to be intercalated, and the presence and/or amount of humidity, among other possible parameters, including those associated with the method of intercalation.

Without intending to be bound by theory, it is believed that the presence of a surfactant may adversely affect the ability for materials to intercalate into clay particles. In some aspects of the present disclosure, the clay particles may not comprise a surfactant, e.g., the clay particles may not be pre-processed with a surfactant such as a dispersant. Thus, the compositions herein may comprise less than 0.5% by weight of surfactant with respect to the total weight of the composition, e.g., less than about 0.2%, less than about 0.1%, less than about 0.05%, or less than about 0.01% by weight surfactant. In some examples, the composition does not comprise a surfactant.

The materials may be intercalated into the clay particles by grinding, e.g., in a ball mill or other suitable grinder. The grinding speed may range from about 50 revolutions per minute (RPM) to about 600 RPM, such as from about 100 RPM to about 500 RPM, e.g, a speed of about 100 RPM, about 150 RPM, about 200 RPM, about 250 RPM, about 300 RPM, about 350 RPM, about 400 RPM, about 450 RPM, about 500 RPM, about 550 RPM, or about 600 RPM. Further, the mixture may be ground for a duration of time ranging from about 15 minutes to about 5 hours, such as from about 30 minutes to about 3 hours, from about 1 hour to about 2 hours, e.g., about 45 minutes, about 1 hour, about 1.5 hour, about 2 hours, about 2.5 hours, or about 3 hours.

The clay particles may have a moisture content of at least 1.0% by weight. For example, the clay materials may comprise from about 1.0% to about 10.0% by weight of water, e.g., from about 2.0% to about 10.0% by weight, from about 1.0% to about 5.0% by weight, from about 1.0% to about 3.0% by weight, or from about 2.0% to about 6.0% by weight water.

In at least one example, the intercalated material may comprise urea, and the clay particles may comprise kaolin. The kaolin particles and urea may be ground together to cause the urea to become intercalated into the kaolinite layers of the kaolin. The amount of urea (urea feed) of the urea/clay mixture may range from about 25% to about 95% urea by weight with respect to the total weight of the mixture, such as from about 30% to about 85% by weight, from about 35% to about 80% by weight, or from about 50% to about 75% by weight. In at least one example, the urea feed comprises greater than 40% by weight, greater than 50% by weight, or greater than 60% by weight, with respect to the total weight of the mixture. Without intending to be bound by theory, it is believed that the amount of urea combined with the clay particles may have a linear relationship to the total amount of urea intercalated into the clay particles.

In some aspects of the present disclosure, the composition may comprise a binder and/or may include a coating, such as a controlled-release or delayed-release coating. The binder and/or coating may provide a physical and/or chemical barrier between the intercalated material(s) and the environment, which may delay contact between the intercalated material(s) and moisture and/or other ambient species that ma.y dissolve or react with the intercalated material(s) to cause the intercalated material(s) to be released. The rate of release of the intercalated material(s) may depend on the chemical composition and/or physical characteristics of the binder and/or coating. For example, a relatively more hydrophobic coating and/or relatively thicker coating may provide for a longer delayed release.

In some aspects of the present disclosure, the composition may comprise at least one hinder. The binder may comprise organic and/or inorganic materials, and may be synthetic or natural in origin. Exemplary binders may include, but are not limited to, polymers and copolymers (including, e.g., biopolymers such as polysaccharides and starches), proteins, alcohols, and nitrogen-containing compounds. For example, the binder may comprise one or more of lignosulfonate (e.g., calcium lignosulfonate), corn syrup, starch (e.g., wheat starch, potato starch, etc.), collagen, gelatin, gelatin/glyoxol, an organic alcohol, urea, or a combination thereof. In some examples, the composition may comprise less than 2% by weight binder with respect to the total weight of the composition, e.g., less than about 1.0% by weight, less than about 0.5% by weight, less than about 0.2% by weight, less than about 0.1% by weight, or less than about 0.05% by weight of binder. For example, the composition may comprise from 0.01% by weight to 1.5% by weight, or from 0.05% by weight to 1.0 by weight, or from 0.5% by weight to 1.0% by weight. In some examples, the composition may not comprise any binder. In some aspects of the present disclosure, the composition may comprise from about 2% to about 70% binder by weight with respect to the total weight of the composition, e.g., from about 5% to about 60% by weight, from about 10% to about 55% by weight, from about 15% to about 50% by weight, from about 20% to about 45% by weight, from about 20% to about 40% by weight, from about 5% to about 15% by weight, from about 15% to about 35% by weight, from about 40% to about 60% by weight, from about 5% to about 10% by weight, from about 55% to about 65% by weight, from about 30% to about 40% by weight, with respect to the total weight of the composition. In some examples, the intercalated material(s) may be uniformly distributed throughout the binder.

Additionally or alternatively to a binder, in some aspects of the present disclosure the composition may comprise a coating. The coating may comprise organic and/or inorganic materials, which may be natural or synthetic. in some aspects of the present disclosure, one or more materials of the coating may be hydrophobic, e.g., such that the coating is at least partially hydrophobic, Non-limiting materials suitable for the coating may include polymers (e.g., thermoplastic resins, polyolefines, rubber), urea decomposition products such as urea-formaldehyde or isobutyledene-diurea, sulfur compounds, minerals (including, e.g., clay minerals such as kaolin or kaoiinite, as well as other minerals such as calcium carbonate), and combinations thereof. In at least one example, the coating may comprise at least one polymer and kaolin. The kaolin may be platy, e.g., having a shape factor greater than 30, greater than 40, or greater than 50.

In some aspects of the present disclosure, the composition may be a fertilizer composition, and may be formed or processed into prills suitable for deposition onto soil or other agricultural medium in need of fertilization. The prills may be rounded in shape having an average diameter ranging from about 0,25 mm to about 7 mm, such as from about 0.5 mm to about 5.0 mm, from about 1.0 mm to about 4.0 mm, from about 1.5 mm to about 3.5 mm, or from about 2.0 mm to about 3,0 mm, In some examples, the prills may be coated with one or more materials or combinations of materials, including the materials discussed above.

The fertilizer composition may be formulated for controlled release. For example, the amount and degree of intercalation of urea into the clay particles may allow for controlled release of nitrogen from the composition over time. The composition may be formulated to provide a controlled, steady release of nitrogen over a period of at least 30 days, at least 60 days, or at least 90 days. In at least one example, the composition may release less than 50% by weight of the total amount of nitrogen of the composition in the first 7 days following deposition onto soil. In at least one example, the fertilizer composition may be a slow release composition, e.g., wherein the composition retains at least 15% nitrogen after 2 hours.

The compositions herein may be useful for additional applications. For example, the compositions may be added to plastics or other polymers to produce nanocomposite materials. Such polymers may include, but are not limited to, polyvinyl chloride (PVC), polylactic acid (PLA), and other polymers useful in a variety of consumer and industrial products and processing methods. The compositions may provide benefits in performance such as greater strength and/or durability. In some examples, a kaolin/urea intercalate may be added to PVC to improve dispersion. In other examples, nanotubes may be prepared using a kaolin/DMSO intercalate composition, and the nanotubes may be incorporated into PLA, a biodegradable polymer. The resulting PLA/kaolin composite materials may have strength values measurably, and significantly higher than pure PLA. Such PLA/kaolin composite materials may have strength values comparable to polypropylene or polystyrene, for example.

Further, the compositions herein may be useful in waste management or remediation technologies, e.g., as an absorbing agent. Many industrial processes such as, e.g., mining, recycling, printing/coatings, etc., create waste streams that can become contaminated with heavy metals. In addition, many potential sources of drinking water contain levels of elements that are much too high for safe human use. The compositions herein may have absorptive properties useful for absorbing metal ions (including, but not limited to, copper and lead) to remove metals from a waste stream or source of drinking water. Additionally or alternatively, the compositions may absorb anion species, such as arsenates, phosphates, sulfates, nitrates, and/or chromates. The intercalated structure of the compositions herein may provide increased surface area and/or surface sites suitable for absorption. For example, the relatively strong hydrogen bonding between layers of kaolinite may be reduced by the insertion of molecules during intercalation. The compositions herein may be subjected to one or more additional processing steps to enhance or improve these absorption properties.

In yet other applications, intercalation may be used as a method to delaminate, or assist in delamination, of kaolin particles, e.g., kaolin booklets. For example, intercalation of kaolin particles through the grinding processes disclosed herein may decrease the strength of hydrogen bonding between layers to facilitate separation of the layers to produce ultrafine kaolin-based particles. Such ultrafine particles may be useful for various applications, including, but not limited to, nano-fillers for polymers, mineral thickeners for gels (including, e.g., cosmetics), drilling fluids or drilling muds (e.g., as a supplement or replacement for bentonite), and/or as micro-particle retention aids in fiber-based materials such as paper and board.

Aspects of the present disclosure are further illustrated by reference to the following, non-limiting numbered exemplary embodiments.

1. A composition comprising clay particles intercalated with urea; wherein the clay particles comprise kaolinite and have a shape factor less than 30; and wherein the composition comprises from about 20% to about 65% by weight intercalated urea, with respect to the total weight of the composition.

2. The composition according to embodiment 1, wherein the composition comprises from about 40% to about 65% by weight intercalated urea, with respect to the total weight of the composition.

3. The composition according to embodiment 1 or 2, wherein the composition has an intercalation ratio ranging from about 80% to 100%.

4. The composition according to any of embodiments 1-3, wherein the clay particles further comprise at least one smectite clay.

5. The composition according to any of embodiments 1-4, wherein the clay particles have a shape factor less than 10.

6. The composition according to any of embodiments 1-5, wherein the clay particles have a d₅₀ particle diameter greater than 0.5 μm.

7. The composition according to any of embodiments 1-6, wherein the clay particles have a d₇₀ particle diameter less than 2.5 μm.

8. The composition according to any of embodiments 1-7, wherein the clay particles are in the form of booklets having a thickness ranging from about 10 μm to about 50 μm.

9. The composition according to any of embodiments 1-8, wherein the composition comprises less than 0.1% by weight of surfactant with respect to the total weight of the composition.

10. The composition according to any of embodiments 1-9, wherein the composition does not comprise a surfactant.

11. The composition according to any of embodiments 1-10, wherein the clay particles intercalated with urea are in the form of prills having an average diameter ranging from about 0.5 mm to about 5 mm.

12. The composition according to embodiment 11, wherein the prills include a coating that comprises at least one of a polymer, a sulfur compound, a mineral, or a combination thereof and/or wherein the prills comprise a binder, e.g., less than 5% by weight or less than 2% by weight, or from about 5% to about 60% binder by weight, with respect to the total weight of the prills.

13. The composition according to embodiment 12, wherein the coating comprises at least one polymer and at least one clay mineral.

14. The composition according to embodiment 13, wherein the at least one clay mineral comprises kaolin having a shape factor greater than 30.

15. The composition according to any of embodiments 1-14, wherein the composition is a controlled-release composition formulated to release nitrogen at a predetermined rate.

16. A controlled-release composition comprising: clay particles comprising kaolinite and having a shape factor less than 30; urea intercalated into the clay particles; and a coating comprising a polymer and a clay mineral having a shape factor greater than 30; wherein the composition comprises from about 20% to about 65% by weight intercalated urea, with respect to the total weight of the composition.

17. The composition according to embodiment 16, wherein the composition comprises from about 40% to about 65% by weight intercalated urea, with respect to the total weight of the composition.

18. The composition according to embodiment 16 or 17, wherein the composition has an intercalation ratio ranging from about 80% to 100%.

19. A method of preparing a composition according to any of embodiments 1-18.

20. The method according to embodiment 19, wherein the composition comprises clay particles intercalated with urea, the method comprising: combining clay particles with urea to form a mixture, wherein the clay particles comprise kaolinite and are in the form of booklets, and wherein the mixture comprises from about 30% to about 85% urea by weight with respect to the total weight of the mixture; and grinding the mixture to intercalate the urea into the clay particles.

21. The method according to embodiment 19 or 20. wherein the composition has an intercalation ratio ranging from about 80% to 100%.

22. The method according to embodiment 20 or 1 wherein the clay particles comprise from about 2% to about 10% water by weight.

23. The method according to any of embodiments 20-22, wherein the mixture is ground with an attritor mill.

24. The method according to embodiment 23, wherein the mixture is ground at a speed ranging from about 50 RPM to about 350 RPM for a time ranging from about 30 minutes to about 5 hours.

25. The method according to any of embodiments 20-24, further comprising forming the composition into prills.

26. The method according to embodiment 25, wherein forming the composition into prills includes combining the clay particles with at least one binder and/or the method further comprising applying a controlled-release coating to the prills.

27. The method according to embodiment 26, wherein the controlled-release coating comprises at least one polymer and kaolin.

28. The method according to embodiment 27, wherein the kaolin has a shape factor greater than 30.

29. Use of the composition according to any of embodiments 1-18 as a fertilizer.

30. A method of fertilizing soil, the method comprising: applying a composition to the soil, the composition comprising clay particles intercalated with urea, the clay particles comprising kaolinite; wherein the clay particles have a shape factor less than 30; and wherein the composition comprises from about 20% to about 65% by weight intercalated urea, with respect to the total weight of the composition.

31. The method according to embodiment 30, wherein the composition has an intercalation ratio ranging from about 80% to 100%.

32. The method according to embodiment 30 or 31, wherein the composition is in the form of prills having an average diameter ranging from about 0.5 mm to about 5 mm.

33. A polymer composition comprising the composition according to any of embodiments 1-18.

34. Use of the composition according to any of embodiments 1-18 as an absorbing agent.

Use of the composition according to any of embodiments 1-18 as a thickening agent.

A drilling fluid comprising the composition according to any of embodiments 1-18.

Other aspects and embodiments of the present disclosure will be apparent to those skilled in the art from consideration of the specification and practice of the embodiments disclosed herein.

### EXAMPLES

The following example is intended to illustrate the present disclosure without, however, being limiting in nature. It is understood that the present disclosure encompasses additional aspects and embodiments consistent with the foregoing description and following example,

### Example 1

Studies were performed with kaolin to test a range of urea levels and grinder speeds. The urea (99.8%, Fisher Scientific) was dry and formed into prills. The kaolin was KT Diamond (Imerys), an air classified grade kaolin without added dispersants or surfactants. The chemical composition and physical properties of the kaolin are shown in Tables 2 and 3, respectively.

TABLE 2
Chemical composition of KT Diamond kaolin

| Chemical species | % wt |
|---|---|
| Fe₂O₃ | 0.55 |
| MgO | 0.13 |
| Al₂O₃ | 38.85 |
| SiO₂ | 44.06 |
| TiO₂ | 1.44 |
| CaO | 0.14 |
| Na₂O | 0.04 |
| K₂O | 0.15 |
| P₂O₅ | 0.10 |
| S | 0.01 |
| LOI | 14.54 |
| Total | 100.0 |

TABLE 3
Physical properties of KT Diamond kaolin

| | |
|---|---|
| PSD < 10 μm | 94.8% |
| PSD < 5 μm | 85.4% |
| PSD < 2 μm | 67.2% |
| PSD < 1 μm | 55.0% |
| PSD < 0.5 μm | 43.1% |
| PSD < 0.25 μm | 27.7% |
| PSD < 0.2 μm | 23.0% |
| PSD < 0.1 μm | 14.7% |
| d₃₀ | 0.277 μm |
| d₅₀ | 0.732 μm |
| d₇₀ | 2.302 μm |
| Mean diameter | 2.730 μm |
| Median diameter | 0.732 μm |
| Shape factor | 8.87 |

The amount of kaolin was kept constant at 50 g, and the amount of urea was varied from 35%-70% by weight with respect to the weight of the kaolin/urea blend, as summarized in Table 4. The individual samples were ground in a Fritsch Pulverisette ball mill with 12-mm bails for one hour. Smaller volume samples (≤50% urea) were milled with 17 balls. Larger volume samples (>50% urea) were milled with 34 balk in a larger grinding vessel.

TABLE 4

| | | | | | Grinder speed |
|---|---|---|---|---|---|
| Sample | Clay (g) | Urea (g) | Total (g) | % Urea feed | (RPM) |
| 1 | 50.0 | 26.9 | 76.9 | 35% | 150 |
| 2 | 50.0 | 50.0 | 50.0 | 50% | 100 |
| 3 | 50.0 | 50.0 | 50.0 | 50% | 200 |
| 4 and 5 | 50.0 | 69.0 | 119.0 | 58% | 150 |
| 6 | 50.0 | 92.9 | 142.9 | 65% | 100 |
| 7 | 50.0 | 92.9 | 142.9 | 65% | 200 |
| 8 | 50.0 | 116.7 | 166.7 | 70% | 150 |

After grinding, each sample was washed three times with isopropyl alcohol to remove the excess non-intercalated urea. For each wash, the ground intercalated sample was placed in a Waring blender with an equal weight of alcohol, the sample was dispersed, and the resulting slurry was filtered. The washed filter cake was dried at 40° C. until dry.

The dried filter cake resulting from each sample was evaluated by XRD to determine the intercalation ratio as an indication of the degree of intercalation. Each dried filter cake also was evaluated by loss on ignition (LOI) to determine the associated urea level. For LOI measurements, the samples were heated at 1050° C. for at least 4 hours. A sample of the feed clay was included in the LOI evaluation to account for the interstitial water in the kaolin lost at 1050° C. Urea was assumed to account for the remaining mass loss. The intercalation ratio and LOT measurements are shown in Table 5.

TABLE 5

| Sample | % Urea feed | Intercalation ratio | LOI % urea product |
|---|---|---|---|
| 1 | 35% | 86% | 27% |
| 2 | 50% | 83% | 41% |
| 3 | 50% | 86% | 40% |
| 4 | 58% | 85% | 49% |
| 5 | 58% | 83% | 48% |
| 6 | 65% | 55% | 55% |
| 7 | 65% | 94% | 54% |
| 8 | 70% | 84% | 59% |

The data in Table 4 indicates that urea levels in excess of 50% may be achieved through the grinding process, with intercalation ratios greater than 80% in most cases. A comparison of the percent urea in the grinder feed to the LOI percent urea in Table 5 suggests that about 10% of the urea is lost in the process. A possible cause of the loss is volatilization of urea during the grinding.

Additional kaolin/urea samples prepared according to the same procedure for urea feed levels of 10%-50% were analyzed, with the results shown in Table 6.

TABLE 6

| | | Grinder speed | | LOI % urea |
|---|---|---|---|---|
| Sample | % Urea feed | (RPM) | Intercalation ratio | product |
| 10 | 10 | 250 | 19% | 4% |
| 9 | 20 | 100 | 54% | 10% |
| 11 | 20 | 180 | 68% | 8% |
| 12 | 20 | 320 | 93% | 12% |
| 13 | 30 | 100 | 57% | 19% |
| 14 | 30 | 180 | 77% | 19% |
| 15 | 30 | 250 | 93% | 19% |
| 16 | 30 | 250 | 94% | 21% |
| 17 | 30 | 400 | 93% | 17% |
| 18 | 40 | 180 | 72% | 30% |
| 19 | 40 | 320 | 89% | 28% |
| 20 | 50 | 250 | 87% | 39% |

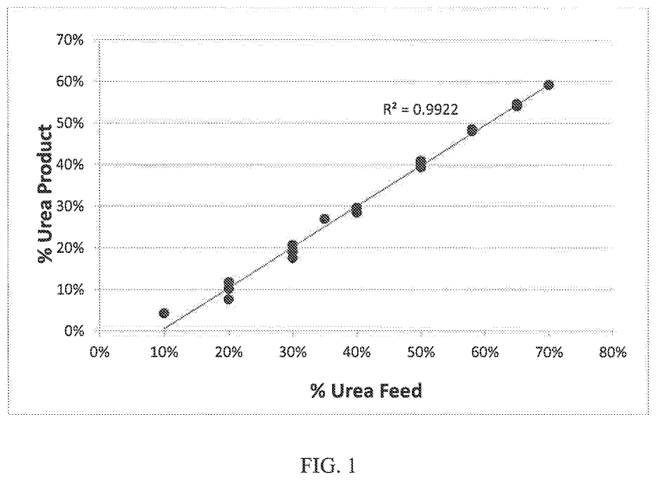

The LOI data from Tables 5 and 6 are plotted in FIG. 1, showing a linear relationship between the levels of urea in the feed and the resulting level of urea in the intercalated product. The grinder speed did not appear to have a strong effect on the amount of intercalation.

### Example 2

Samples of urea intercalated kaolin were processed into granules with various binders for evaluation as slow release fertilizer. Samples of prilled urea and a commercial polymer-coated slow release fertilizer (Agrium ESN®) were also tested for comparison. ESN® is designed to control nitrogen release for 50-80 days.

Urea intercalated kaolin powder comprising 50% urea and 50% kaolin with an intercalation ratio of 90-93% was used to prepare each test sample (Samples 1-11). A Union Process SDLI Attritor mill was used to process the samples, which were ground for 1 hour. The ratio of media to sample was approximately 4:1.

The kaolin/urea powder was screened over an 18 mesh sieve to remove large clumps prior to preparation of Samples 2-11. Screening was not done for Sample 1. Table 7 lists the binders used, the % nitrogen in the dried granule samples prior to testing, and the % nitrogen remaining from the FM-701 test for nitrogen release (discussed below).

TABLE 7

| | | % | % | | |
|---|---|---|---|---|---|
| | | Binder | Binder | | % |
| | | in | in dry | % Nitrogen | Nitrogen |
| Sample | Binder | solution | granules | in granules | remaining |
| 1 | Ca lignosulfonate | 29 | 3.97 | 22.53 | 14.90 |
| 2 | Ca lignosulfonate | 29 | 4.23 | 22.15 | 18.23 |
| 3 | Corn syrup | 30 | 4.30 | 22.21 | 35.56 |
| 4 | Wheat starch | n/a | 3.00 | 23.10 | 8.68 |
| 5 | Fish | 22 | 3.70 | 23.22 | 9.96 |
| | gelatin/glyoxol | | | | |
| 6 | (Water only) | n/a | 0 | 22.67 | 0.00 |
| 7 | Polyvinyl alcohol | 9.8 | 1.35 | n/a | n/a |
| 8 | Urea | 95 | 50 | 34.51 | 15.99 |
| 9 | Urea | 95 | 45 | 35.39 | 18.01 |
| 10 | Urea | 95 | 40 | 37.20 | 15.72 |
| 11 | Urea | 95 | 33 | 37.93 | 2.67 |
| Prilled | — | — | — | 46.00 | 4.67 |
| urea | | | | | |
| ESN | — | — | — | 43.57 | 97.65 |

Preparation of Samples 1-3 and 5-7: The kaolin/urea powder was weighed on a laboratory balance. Binder solutions for Samples 1-3, 5, and 7 were prepared in water at the concentrations listed in Table 7 and placed into laboratory spray bottles. Water only was used for Sample 6. Each spray bottle with the binder solution was placed onto the laboratory balance and tared. Approximately one-third of the kaolin/urea powder was placed into a laboratory pan granulator measuring 20 inches in diameter and 3 inches in depth and tilted 50 degrees from the horizontal. The pan granulator started rotating, controlled by a ⅓ HP Baldor motor and variable speed motor controller. Once the powder was rotating, the binder solution was sprayed onto the rolling bed to start the formation of granules. Once granules began to form, additional powder was added to the rolling bed of granules in the pan granulator to dry the granules. During the granulation, a scraper was used to form the rolling bed and hand pressure was used to break down larger particles. The spraying of the binder solution and additional powder were alternated until all of the powder was added and the granules formed appeared to be in the proper particle size range. The spray bottle was placed back on the tared balance and the weight of the binder solution applied was recorded. A hot air gun was used to dry the bed of rolling granules until the surface was dry. The granules were then removed from the pan granulator and placed into an aluminum pan before placing into a laboratory oven to dry over night at 150° F. Once dry, the granules were screened to a product size of −5+8 Tyler mesh (about 2.4 mm to 4.0 mm) and placed into a labeled sample bag. The under size and over size for each test was also placed into labeled sample bags.

Preparation of Sample 4: The kaolin/urea powder was weighed on a laboratory balance and combined with dry wheat starch.

Preparation of Sample 8-11: Molten urea was used so that the nitrogen level of the resulting granules could be controlled to meet the targets for specific fertilizer markets. To prepare these samples, a small propane torch first was placed behind the pan granulator to preheat the pan. The urea granules were weighed into a beaker and placed on a hotplate to melt. Enough water was added to the urea to make a 95% urea concentration. While the urea was melting, the screened kaolin/urea powder was weighed into a plastic beaker. Once the urea was completely melted, the kaolin/urea powder was added to the molten urea while stirring with a glass stir rod. Once all of the powder was added to the molten urea, the mixture was allowed to heat on the hotplate while stirring long enough for the mixture to be fluid enough to pour from the beaker. After the mixture was fluid, the beaker was removed from the hotplate, and the mixture was poured into the preheated pan granulator. The mixture was broken down into granules by hand pressure and allowed to roll and solidify. Once the granules had solidified, they were removed from the pan granulator and screened to a product size of −5+8 Tyler mesh. The product was placed into a labeled sample bag. The under size and over size for each test was also placed into labeled sample bags.

Each dried granular sample was analyzed for total nitrogen content using a Leco CN628 combustion analyzer, which burns the sample in an oxygen rich atmosphere and the resulting gases are measured for nitrogen content by thermal conductivity. The results, including total nitrogen analyses, are shown in Table 7, along with the nitrogen content for prilled urea and ESN®. As shown in Table 7, most samples contained about 22% to 23% nitrogen, with higher levels of nitrogen for the samples prepared with molten urea.

Nitrogen release from the test samples, and from the urea and ESN® reference samples, was evaluated using FM-701, a test from the Florida Department of Agriculture that provides a high level classification of slow release fertilizers. In this method, a representative 3 g sample is placed in a chromatography column and 2 mL/minute of distilled water is passed over the granules for 2 hours. At the end of the 2 hour period, the water solution is analyzed for total nitrogen to determine the amount of the starting nitrogen remaining in the granules. If the amount of nitrogen remaining is greater than 15%, the product is characterized as a slow release product. FM-701 provides an indication of the ability of a granular material to serve as a slow release fertilizer.

Sample 2 (Ca lignosulfonate; screened particles), Sample 3 (corn syrup), and Samples 8-10 (50%, 45%, and 40% urea binder) met the criteria for slow-release. Sample 1 (Ca lignosulfonate; unscreened particles) fell just below the 15% threshold of remaining nitrogen. Sample 7 (polyvinyl alcohol binder) fell apart upon exposure to the water and clogged the chromatography columns, therefore no results are available. Sample 11 (33% urea binder) provided less than 3% remaining nitrogen, and Sample 6 (water only) released all nitrogen (0% remaining nitrogen). These results indicate that binders play a significant role in reducing the release of nitrogen (urea) from urea-intercalated clay samples.

It is intended that the specification and examples be considered as exemplary only, with a true scope and spirit of the present disclosure being indicated by the following claims.

1. A composition comprising clay particles intercalated with urea;
wherein the clay particles comprise kaolinite and have a shape factor less than 30; and
wherein the composition comprises from about 20% to about 65% by weight intercalated urea, with respect to the total weight of the composition.

2. The composition of claim 1, wherein the composition comprises from about 40% to about 65% by weight intercalated urea, with respect to the total weight of the composition.

3. The composition of claim 1, wherein the composition has an intercalation ratio ranging from about 80% to 100%.

4. The composition of claim 1, wherein the clay particles further comprise at least one smectite clay.

5. The composition of claim 1, wherein the clay particles have a shape factor less than 10.

6. The composition of claim 1, wherein the clay particles have a d₅₀ particle diameter greater than 0.5 μm.

7. The composition of claim 1, wherein the clay particles have a d₇₀ particle diameter less than 2.5 μm.

8. The composition of claim 1, wherein the clay particles are in the form of booklets having a thickness ranging from about 10 μm to about 50 μm.

9. The composition of claim 1, wherein the composition comprises less than 0.1% by weight of surfactant with respect to the total weight of the composition.

10. The composition of claim 1, wherein the composition does not comprise a surfactant.

11. The composition of claim 1, wherein the clay particles intercalated with urea are in the form of prills having an average diameter ranging from about 0.5 mm to about 5 mm.

12. The composition of claim 11, wherein the prills include a coating that comprises at least one of a polymer, a sulfur compound, a mineral, or a combination thereof.

13. The composition of claim 12, wherein the coating comprises at least one polymer and at least one clay mineral.

14. The composition of claim 11, wherein the prills comprise a binder.

15. The composition of claim 14, wherein the prills comprise less than about 5% binder by weight, with respect to the total weight of the prills.

16. The composition of claim 13, wherein the at least one clay mineral comprises kaolin having a shape factor greater than 30.

17. The composition of claim 11, wherein the composition is a controlled-release composition formulated to release nitrogen at a predetermined rate.

18. A controlled-release composition comprising:
clay particles comprising kaolinite and having a shape factor less than 30;
urea intercalated into the clay particles; and
a coating comprising a polymer and a clay mineral having a shape factor greater than 30;
wherein the composition comprises from about 20% to about 65% by weight intercalated urea, with respect to the total weight of the composition.

19. The controlled-release composition of claim 18, wherein the composition comprises from about 40% to about 65% by weight intercalated urea, with respect to the total weight of the composition.

20. The controlled-release composition of claim 18, wherein the composition has an intercalation ratio ranging from about 80% to 100%.

21-33. (canceled)
